(19) United States
(12) Patent Application Publication
(10) Pub. No.: US 2012/0038160 A1
(43) Pub. Date: Feb. 16, 2012

(54) COMPOUND POWER GENERATING SYSTEM

(76) Inventor: Lin Wen Chang, Linyuan Township (TW)

(21) Appl. No.: 12/856,678

(22) Filed: Aug. 15, 2010

(51) Int. Cl. F03D 9/02; F02B 43/00

(52) U.S. Cl. 290/50; 60/39.12

(57) ABSTRACT

A compound power generating system comprises a housing unit, a power unit, a rotation unit, at least one oxyhydrogen generating unit and a combustion unit. In the present invention, the collected solar energy is transformed into electric energy to drive the oxyhydrogen generating unit to generate fuel gas, and then the combustion unit burns the fuel gas to generate the updraft air to cause the fans to drive the kinetic generator to generate electrical energy. Therefore, the solar energy is indirectly transformed into the mechanical kinetic energy to drive the kinetic generator.

### BACKGROUND OF THE INVENTION

1. Field of the Invention

The present invention relates to a power generating system, and more particularly to a compound power generating system.

2. Description of the Related Art

Since the Earth has limited resources for power generation, new energy sources and the development of green energy is becoming an increasingly important goal. For example, wind energy, hydroelectric energy, solar energy, thermal energy or any type from recycled energy, etc, may be lower in cost, avoid environmental pollution and are renewable.

Currently, solar power and wind power are more mature and popular technologies. However, both solar power and wind power are restricted by environmental factors, such as, day length and seasonal wind speeds. Therefore, a compound power generating system was developed, as shown in FIG. 1. This prior art compound power generating system comprises a water pump 11, a wind power source unit 12, a compressor unit 13, a transforming unit 14, and a cycling unit 15.

The transforming unit 14 transforms the hydro-power and wind power into mechanical kinetic energy that drives a generator 16. However, the greater the horsepower of the water pump 17 and a blower 18 the greater the equipment costs are. Moreover, these pumps and blowers require frequent repairs. Therefore the efficiency of the power generation system may be limited.

Therefore, it is desirable to provide a compound power generating system to mitigate and/or obviate the aforementioned problems.

### SUMMARY OF THE INVENTION

An objective of the present invention is to provide a compound power generating system.

In order to achieve the above-mentioned objectives a compound power generating system comprises a housing unit, a power unit, a rotation unit, at least one oxyhydrogen generating unit and a combustion unit. The housing unit has a hollow housing defining an airflow space, a vent connected to the airflow space at a top end of the housing and used for releasing air from the airflow space, and at least one intake connected to the airflow space and used for introducing external air.

The power unit comprises a plurality of solar power generators disposed on the housing and capable of transforming solar energy into electrical energy, and a kinetic generator disposed in the housing and capable of transforming kinetic energy into electrical energy.

The rotation unit comprises a shaft connected to the kinetic generator and capable of driving the kinetic generator, and a plurality of fans separately disposed on the shaft.

The oxyhydrogen generating unit comprises an electrolytic bath filled with an electrolyte and a plurality of electrodes disposed in the electrolytic bath and electrically connected to the solar power generator, each electrode utilizing the electrical energy output by the solar power generator to electrolyze the electrolyte to generate an oxyhydrogen mixture.

The combustion unit is disposed in the housing and comprises at least one blower capable of utilizing the oxyhydrogen mixture as fuel to generate heat, the blower capable of heating air in the airflow space to generate an airflow to drive the fans to rotate. In the present invention, the collected solar energy is transformed into electric energy to drive the oxyhydrogen generating unit to generate fuel gas, and then the combustion unit burns the fuel gas to generate the updraft air to cause the fans to drive the kinetic generator to generate electrical energy. Therefore, the solar energy is indirectly transformed into the mechanical kinetic energy to drive the kinetic generator.

Other objects, advantages, and novel features of the invention will become more apparent from the following detailed description when taken in conjunction with the accompanying drawings.

### BRIEF DESCRIPTION OF THE DRAWINGS

FIG. 1 is a function block diagram of a prior art compound power generating system.

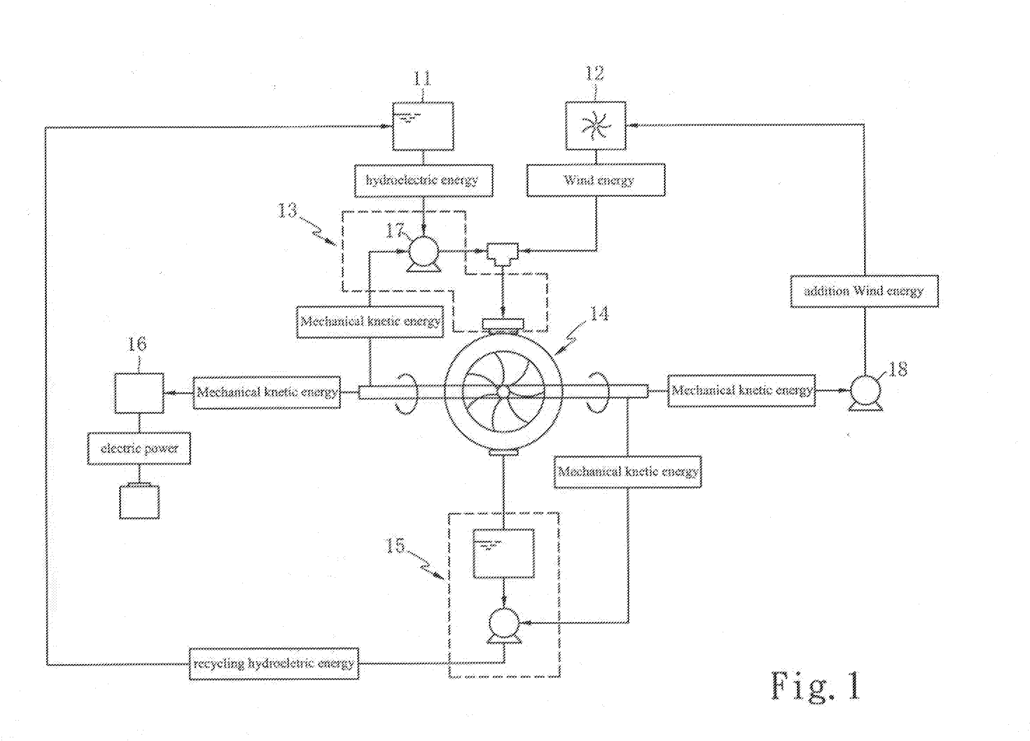

FIG. 2 is a schematic drawing of a first embodiment of a compound power generating system according to the present invention.

FIG. 3 is a top view of an embodiment of the present invention.

FIG. 4 is a schematic drawing of connections among a solar power generator, an oxyhydrogen generating unit and a combustion unit according to an embodiment of the present invention.

FIG. 5 is a flowchart of the first embodiment according to the present invention.

FIG. 6 is a schematic drawing of a second embodiment of a compound power generating system according to the present invention.

### DETAILED DESCRIPTION OF THE PREFERRED EMBODIMENT

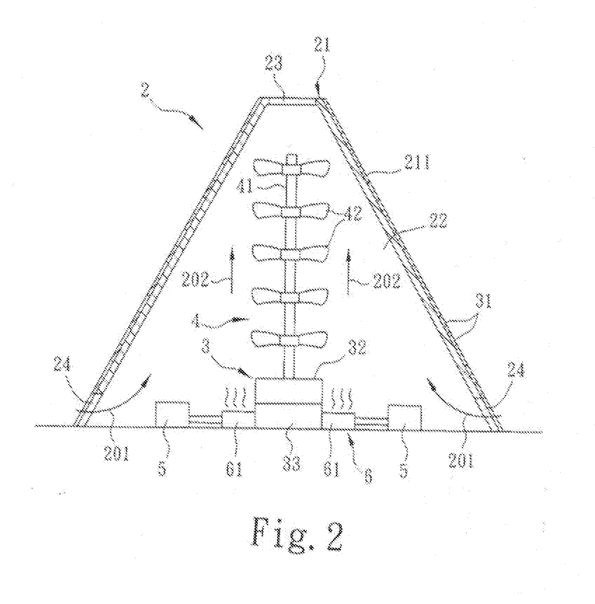

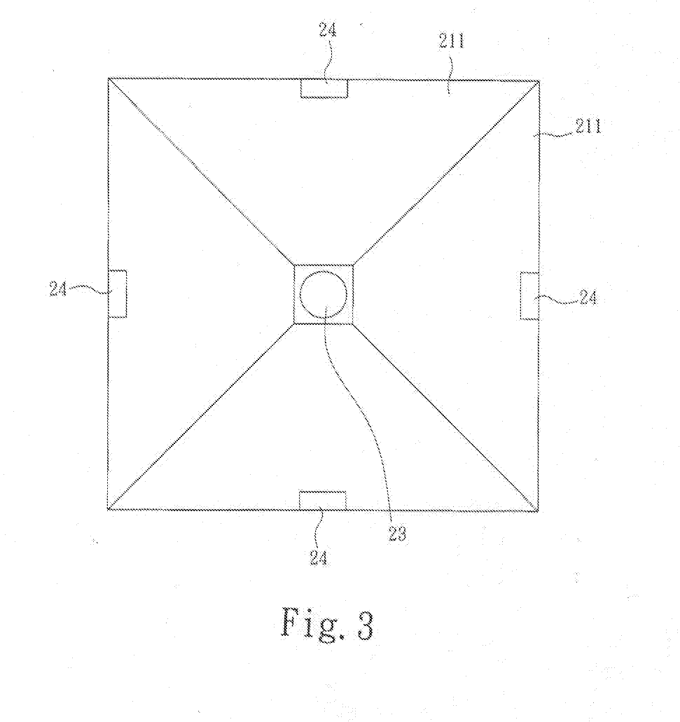

As shown in FIG. 2 and FIG. 3, in a first embodiment, a compound power generating system comprises a housing unit 2, a power unit 3, a rotation unit 4, two oxyhydrogen generating units 5 and a combustion unit 6.

The housing unit 2 has a hollow housing 21 defining an airflow space 22, a vent 23 connected to the airflow space 22 at a top end of the housing 21 and used for releasing air from the airflow space 22, and four intakes 24 connected to the airflow space 22 and used for introducing external air.

In this embodiment, the housing 21 has a pyramidal shape with four inclined faces 211 and the four intakes 24 respectively disposed on each inclined face 211. The housing 21 might have a cone shape or a polyhedron pyramidal shape, which enhances a the air flow in the airflow space 22 towards the vent 23, which is shown as arrow 202.

The power unit 3 comprises a plurality of solar power generators 31 respectively disposed on each inclined face 211 of the housing 21 and that are capable of transforming solar energy into electrical energy; a kinetic generator 32 disposed in the housing 21 and capable of transforming kinetic energy into electrical energy, and a rechargeable battery 33 electrically connected to the kinetic generator 32 and used for storing the electrical energy generated by the kinetic generator 32.

The rotation unit 4 comprises a shaft 41 connected to the kinetic generator 32 and capable of driving the kinetic generator 32, and a plurality of fans 42 separately disposed on the shaft 41. Rotations of the shaft 41 cause coils (not shown) in the kinetic generator 32 to generate an electromotive force that creates a current. Since the structure and technology of the kinetic generator 32 is well known, it requires no further description.

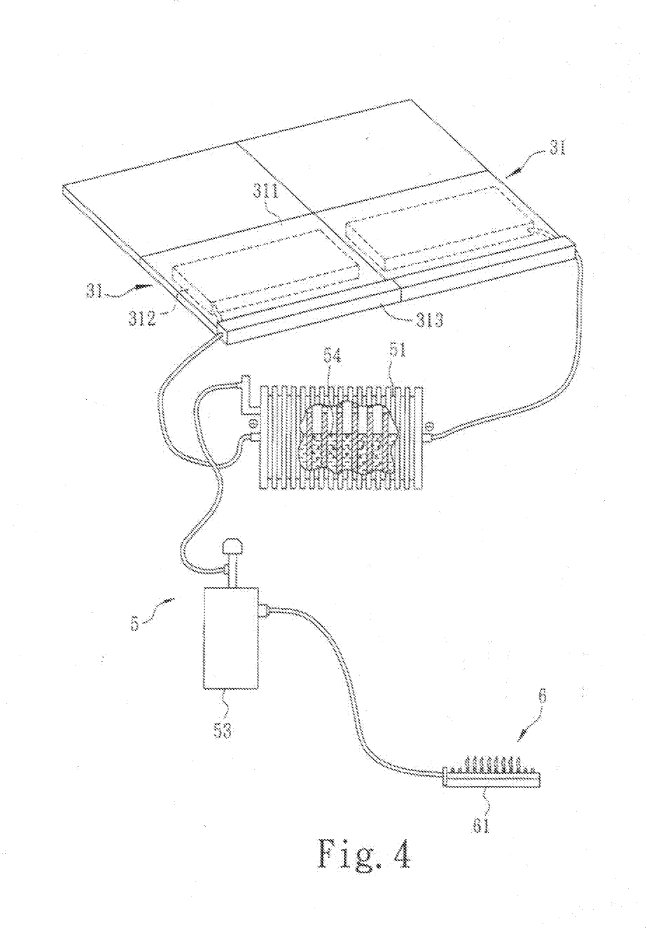

As shown in FIG. 4 (for purposes of explanation, only four solar power generators 31, and an oxyhydrogen generating unit 5 are shown), each solar power generator 31 comprises a solar panel 311 for collecting and transforming solar energy into electrical energy, an energy storage device 312 electrically connected to the solar panel 311 and capable of storing the electrical energy, and a controller 313 electrically connected to the energy storage device 312.

The solar panel 311 of each solar power generator 31 is made from a semiconductor material, which is capable of utilizing solar energy to raise the to generate free electrons and holes that generates a voltage potential to create an electric current.

Each oxyhydrogen generating unit 5 comprises an electrolytic bath 51 filled with an electrolyte 54, a plurality of electrodes 52 disposed in the electrolytic bath 51 and electrically connected to the solar power generator 31, and a gas storage tank 53 connected to the electrolytic bath 51 and used for storing the oxyhydrogen mixture. Each electrode 52 utilizes the electrical energy output by the solar power generator 31 to electrolyze the electrolyte 54 to generate an oxyhydrogen mixture. The controller 313 of the solar power generator 31 controls the electrical energy output to each electrode 52 of the oxyhydrogen generating unit 5.

As shown in FIGS. 2 and 4, the combustion unit 6 is disposed in the housing 21 and comprises two blowers 61 which are capable of utilizing the oxyhydrogen mixture stored in the gas storage tank 53 as fuel to generate heat for heating air in the airflow space 22 to generate an airflow indicated by arrow 202, to drive the fans 42 to rotate.

In addition, a user can utilize one or multiple oxyhydrogen generating units 5 based on the actual amount of the oxyhydrogen mixture, and the number of blowers 61 can also be varied based on the size of the airflow space 22.

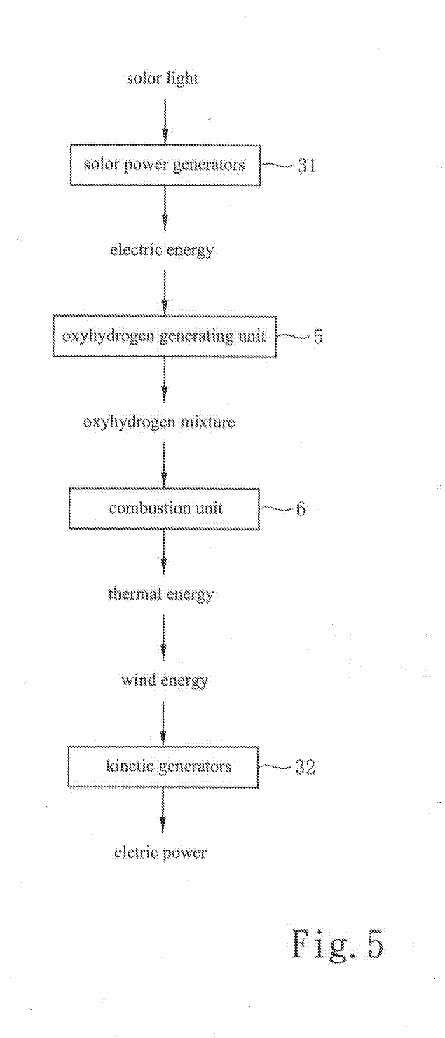

As shown in FIG. 5, in the compound power generating system, the solar power generator 31 collects solar energy to generate electrical energy so that the oxyhydrogen generating unit 5 can generate the oxyhydrogen mixture, and the blower 61 of the combustion unit 6 burns the oxyhydrogen mixture to heat the air in the airflow space 22. The heated air then moves towards the vent 23 to generate an updraft indicated by arrow 202. External air also generates thermal convection, shown by arrow 201, that enters into the airflow space 22 via the intake 24, such that the fans 42 are driven by the updraft to rotate the shaft 41, and the kinetic generator 32 is driven by the shaft 41 to generate electric energy.

With the above-mentioned design, the compound power generating system of the present invention has following benefits:

1. Higher power generating efficiencies: compared to the limitations imposed by pumps for moving fluid in the prior art, the compound power generating system of the present invention can utilize different numbers or sizes of fans 42, or increase the number of intakes 24, to increase the flux of the updraft in the airflow space 22, to maximum the power generated by the kinetic generator 32.

2. Simple structural design: since the prior art must compress the fluid using a compressing unit to drive the transforming unit to generate power and also requires a recycling unit to recycle the fluid flow and air flow, it has a more complicated structure. However, the compound power generating system of the present invention generates updraft air by burning the oxyhydrogen mixture, which employs a simple structure.

3. Environment friendly: the compound power generating system of the present invention utilizes the solar power generator 31, the oxyhydrogen generating unit 5 and the combustion unit 6 to generate the updraft air to drive the kinetic generator 32, which needs no water for power generation.

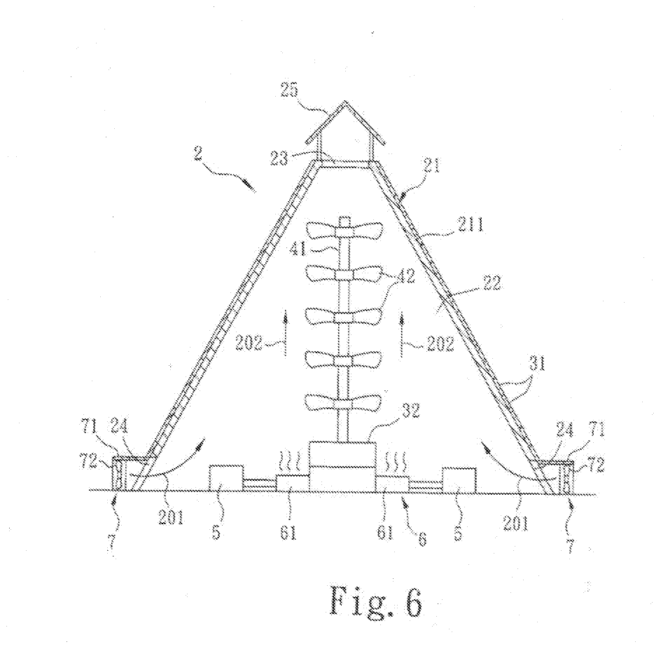

As shown in FIGS. 6 and 7, in a second embodiment of the compound power generating system, a difference from the first embodiment is that the housing unit 2 further comprises a cover 23 disposed on an upper edge of the housing 21 and that is used for covering the vent 23, such that external debris and rain can be blocked to protect the parts in the housing 21.

Moreover, the compound power generating system further comprises a draw unit 7 for bringing external air into the airflow space 22. The draw unit 4 has four bases 71 correspondingly connected to the four intakes 24 and respectively disposed on each inclined face 211, and four draw fans 72 respectively disposed on each base 71 and capable of bringing external air into the airflow space 22. Since the draw fans 72 increase the amount of introduced external air, the increased flux of the updraft air increases the rotational speeds of the fans 42, which boosts the amount of generated power.

Accordingly, the collected solar energy is transformed into electric energy to drive the oxyhydrogen generating unit 5 to generate fuel gas, and then the combustion unit 6 burns the fuel gas to generate the updraft air to cause the fans 42 to drive the kinetic generator 32 to generate electrical energy. Therefore, the solar energy is indirectly transformed into the mechanical kinetic energy to drive the kinetic generator 32.

Although the present invention has been explained in relation to its preferred embodiment, it is to be understood that many other possible modifications and variations can be made without departing from the spirit and scope of the invention as hereinafter claimed.

What is claimed is:

1. A compound power generating system comprising:
a housing unit having a hollow housing defining an airflow space, a vent connected to the airflow space at a top end of the housing and used for releasing air from the airflow space, and at least one intake connected to the airflow space and used for introducing external air;
a power unit comprising a plurality of solar power generators disposed on the housing and capable of transforming solar energy into electrical energy, and a kinetic generator disposed in the housing and capable of transforming kinetic energy into electrical energy;
a rotation unit comprising a shaft connected to the kinetic generator and capable of driving the kinetic generator, and a plurality of fans separately disposed on the shaft;
at least one oxyhydrogen generating unit comprising an electrolytic bath filled with an electrolyte and a plurality of electrodes disposed in the electrolytic bath and electrically connected to the solar power generator, each electrode utilizing the electrical energy output by the solar power generator to electrolyze the electrolyte to generate an oxyhydrogen mixture; and
a combustion unit disposed in the housing and comprising at least one blower capable of utilizing the oxyhydrogen mixture as fuel to generate heat, the blower capable of heating air in the airflow space to generate an airflow to drive the fans to rotate.

2. The compound power generating system as claimed in claim 1, wherein the housing has a tapered shaped.

3. The compound power generating system as claimed in claim 2, wherein the housing has a tapered shape with multiple inclined faces and a plurality of intakes connected to the airflow space and respectively disposed on each inclined face, and the solar power generator is also respectively disposed on each inclined face.

4. The compound power generating system as claimed in claim 3 further comprising a draw unit for bringing external air into the airflow space, the draw unit having at least one base correspondingly connected to the at least one intake and respectively disposed on each inclined face, and at least one draw fan respectively disposed on each base and capable of bringing external air into the airflow space.

5. The compound power generating system as claimed in claim 1, wherein the housing unit further comprises a cover disposed on an upper edge of the housing and used for covering the vent.

6. The compound power generating system as claimed in claim 1, wherein the power unit further comprises a kinetic generator and a reusable battery for storing the electrical energy generated by the kinetic generator.

7. The compound power generating system as claimed in claim 1, wherein the oxyhydrogen generating unit further comprises a gas storage tank connected to the electrolytic bath, which is used for storing the oxyhydrogen mixture.

8. The compound power generating system as claimed in claim 1, wherein each solar power generator comprises a solar panel for collecting and transforming solar energy into electrical energy, an energy storage device electrically connected to the solar panels and capable of storing the electric energy, and a controller electrically connected to the energy storage device, such that the controller controls electrical energy output to the electrodes of the oxyhydrogen generating unit.

9. The compound power generating system as claimed in any one of claims 2, wherein the housing unit further comprises a cover disposed on an upper edge of the housing and used for covering the vent.

10. The compound power generating system as claimed in any one of claims 3, wherein the housing unit further comprises a cover disposed on an upper edge of the housing and used for covering the vent.

11. The compound power generating system as claimed in any one of claims 4, wherein the housing unit further comprises a cover disposed on an upper edge of the housing and used for covering the vent.

12. The compound power generating system as claimed in any one of claims 2, wherein the power unit further comprises a kinetic generator and a reusable battery for storing the electrical energy generated by the kinetic generator.

13. The compound power generating system as claimed in any one of claims 3, wherein the power unit further comprises a kinetic generator and a reusable battery for storing the electrical energy generated by the kinetic generator.

14. The compound power generating system as claimed in any one of claims 4, wherein the power unit further comprises a kinetic generator and a reusable battery for storing the electrical energy generated by the kinetic generator.

15. The compound power generating system as claimed in any one of claims 2, wherein the oxyhydrogen generating unit further comprises a gas storage tank connected to the electrolytic bath, which is used for storing the oxyhydrogen mixture.

16. The compound power generating system as claimed in any one of claims 3, wherein the oxyhydrogen generating unit further comprises a gas storage tank connected to the electrolytic bath, which is used for storing the oxyhydrogen mixture.

17. The compound power generating system as claimed in any one of claims 4, wherein the oxyhydrogen generating unit further comprises a gas storage tank connected to the electrolytic bath, which is used for storing the oxyhydrogen mixture.

18. The compound power generating system as claimed in any one of claims 2, wherein each solar power generator comprises a solar panel for collecting and transforming solar energy into electrical energy, an energy storage device electrically connected to the solar panels and capable of storing the electric energy, and a controller electrically connected to the energy storage device, such that the controller controls electrical energy output to the electrodes of the oxyhydrogen generating unit.

19. The compound power generating system as claimed in any one of claims 3, wherein each solar power generator comprises a solar panel for collecting and transforming solar energy into electrical energy, an energy storage device electrically connected to the solar panels and capable of storing the electric energy, and a controller electrically connected to the energy storage device, such that the controller controls electrical energy output to the electrodes of the oxyhydrogen generating unit.

20. The compound power generating system as claimed in any one of claims 4, wherein each solar power generator comprises a solar panel for collecting and transforming solar energy into electrical energy, an energy storage device electrically connected to the solar panels and capable of storing the electric energy, and a controller electrically connected to the energy storage device, such that the controller controls electrical energy output to the electrodes of the oxyhydrogen generating unit.
